(19) United States
(12) Patent Application Publication
(10) Pub. No.: US 2004/0073447 A1
(43) Pub. Date: Apr. 15, 2004

(54) Apparatus and methods for interactive rental information retrieval and management

(76) Inventors: Joshua L. Stuart, Lutherville, MD (US); Larry K. Cyford, Union Bridge, MD (US); Michael A. Szczawinski, Phoenix, MD (US); Jeffrey B. Wolf, Jarrettsville, MD (US); Wendy P. Dixler, Baltimore, MD (US)

Correspondence Address: R. Lewis Gable, Cowan, Liebowitz & Latman, P.C., 1133 Avenue of the Americas, New York, NY, 10036, US

(21) Appl. No.: 10/647,016

(22) Filed: Aug. 22, 2003

Related U.S. Application Data
(62) Division of application No. 09/532,563, filed on Mar. 22, 2000, now abandoned.

(51) Int. Cl. G06F 17/60

(52) U.S. Cl. 705/1

(57) ABSTRACT

A method is disclosed for constructing and managing a database to permit an organization of employee or customers renters to analyze vehicle transaction information. The method comprises the steps of inputting to the database a plurality of files. Each file defines a vehicle rental transaction and includes a parameter indicative of the vehicle rental location in terms of a plurality of geographical divisions of different granularity and a parameter indicative of an attribute of its vehicle rental transaction. The organization is permitted to select the granularity of the geographic division and to identify the vehicle rental transactions originating from the geographic division of selected granularity. The parameter is collected from all of the identified vehicle rental transactions to provide an indication of the collected parameter from all of the rental locations within the geographic divisions of the selected granularity. The geographic divisions include selected of street addresses, cities, states, provinces, countries and combinations of countries. The second parameter may comprise selected of expenditures involved in the rental transaction, the method of payment, the duration of the rental, the date of the rental and the affiliated organization of the renter.

### BACKGROUND OF THE INVENTION

1. Field of the Invention

This invention relates to rental data analysis and more specifically to extracting and analyzing rental information at various levels of detail.

2. Description of the Background of the Invention

In the vehicle rental industry, most if not all of the companies, particularly the larger companies, have databases for taking and storing reservations and rentals, as well as the other parameters associated with a vehicle rental transaction. Typically, these parameters would include among others: 1) the name of the vehicle renter, as well as home and business addresses to complete a profile on each vehicle renter; 2) an unique identification of the rented vehicle; 3) the rental charge; 4) the beginning and ending dates of a vehicle rental in terms of the day in the month and the week day that a particular vehicle was rented; 5) the miles that a rental vehicle was driven; 6) the location from which the vehicle was rented in terms of street address, city, state or province and country; 7) the location to which the vehicle was returned; and 8) any upgrade that was given and the kind. These parameters would be kept for all vehicle rentals. If the vehicle renter is an employee of a company, the retained parameters may also include the name and address of the employer/company.

Such reservation and rental databases have been maintained and used by the vehicle rental companies for servicing and tracking vehicle rental transactions. Access to such databases has typically been limited to the vehicle rental company employees. The potential usc of this data management tool by vehicle renters and their employers, travel agencies, consortiums, tour operators and associations has been ignored. The vehicle renter and their employers receive documents and are aware of the charges they have paid, but are not aware of how their companies, employees, or customers have used these vehicle rental services. It would be of significant benefit to the companies if they had a management tool that would facilitate its analysis of this data and generate a variety of reports that would indicate whether their vehicle rental expenditures were well used. Often there are problems of personal use or misuse of vehicle rentals, or perhaps even fraud on the company. Large companies have travel managers whose job it is to keep track and analyze their company's use of vehicle rentals to ensure that there is no fraud on the company, to minimize such cost to the company, and to ensure the most efficient use of vehicle rentals to meet the goals of the company. No one report or even a small number of reports can meet these needs of a company's vehicle rental manager. Further, these needs change as the business of a company changes and grows. A travel manager may need a certain set of reports for a period of time, and then as the business changes or a new need is recognized, will want to secure a different set of reports.

Any system developed to store and to process the above described vehicle rental data would need to be flexible. As noted, the real and perceived needs of one company will change over time, thereby requiring that a database management system be flexible, particularly in terms of the parameters to be collected and the reports it can generate. Further, the needs of one company in terms of the reports needed will differ from those of another company. Therefore, a vehicle rental database system must be able to provide data in a format or a report that will meet the needs of a wide variety of users, whether large companies, private individuals, or associations.

In the advent of wide area networks (WANS) such as the Internet, databases including those dedicated to storing vehicle rental data may be readily and inexpensively accessed from any place in the world. These databases may be accessed not only by the travel managers of large and small companies as suggested above, but also by a wide variety of other people. Individual vehicle renters would have the need to access data from such databases. Employees of the vehicle rental companies would need to use such databases for a wide variety of purposes. Data could be gathered about one or a selected number of companies, about rentals at selected vehicle locations within one geographic unit, e.g., the United States, or a number of selected geographic units, e.g., the United States, Canada and Mexico, or about selected of their customers, whether companies or individuals. In addition to vehicle rental companies and their corporate customers, other users such as travel agents could access the contemplated database system and obtain needed information. Available WANS can readily facilitate access by the people noted above and others to access the flexible vehicle rental database system of this invention.

### SUMMARY OF THE INVENTION

It is an object of this invention to facilitate the generation of a wide variety of reports that may be used as tools to analyze data related to vehicle rentals.

It is a further object of this invention to permit a number of people, e.g. a vehicle transaction manager for an employer company, a sales person for the rental car company, for MI personnel for the database service company, vehicle renters, etc. to have access to the vehicle rental data.

It is another object of this information to permit the uses of this invention to analyze the data at varying levels of granularity.

It is a more particular object of this invention to examine the vehicle rental data as may be collected from different geographical divisions, i.e., to collect and sum data that originated from all vehicle rental locations in a particular country, combination of countries, states or provinces, cities or street locations.

In accordance with these and other objects of the invention, there is describe a method of extracting rental information from a database and analyzing the extracted rental information. The rental information relates to at least first and second parameters. The first parameter includes at least first and second levels of detail. The first level of detail corresponds to the finest level of detail. The method comprises the steps of constructing at least first and second tables. The first and second tables include pluralities of first and second rows respectively. Each first row comprises at least a first parameter, and each second row comprises a second parameter. The first and second parameters define different attributes of the rental transaction. Next, one of the plurality of the first rows is combined with one of the second rows to form a summary record. Then, each of the summary records is accessed with the first parameter to a selected of the first and second levels of detail. The second parameters of the accessed summary records are summed to provide a summed indication of the second parameter to the first level of detail. In an illustrated embodiment of this invention, the first parameter defines the geographic division of the rental location, and the second parameter defines the expenditure involved in the rental transaction. The geographic division of said first level is relatively smaller than the geographic division of the second level. The geographic divisions include selected of street addresses, cities, states, provinces, countries and combinations of countries. The second parameter may comprise selected of expenditures involved in the rental transaction, the method of payment, the duration of the rental, the date of the rental and the employer of the renter.

In a further aspect of this invention, each of the first and second files are constructed with a third parameter. Then, the third parameter of one of the first files is compared with the third parameter of one of the second files. If there is a match, the first and second files are combined to form the summary record. The third parameter comprises an ID uniquely identifying one of the plurality of the rental locations.

In a further aspect of this invention, a method of constructing and managing a database is described to permit an employer of employee renters, travel agents, associations of members or travel agency or tour operators of customers to analyze vehicle transaction information. The method comprises the steps of inputting to the database a plurality of files. Each file defines a vehicle rental transaction and includes a parameter indicative of the vehicle rental location in terms of a plurality of geographical divisions of different granularity and a parameter indicative of an attribute of its vehicle rental transaction. Next, the organization is permitted to select the granularity of the geographic division and to identify the vehicle rental transactions originating from the geographic division of selected granularity. The parameters are collected from all of the identified vehicle rental transactions to provide an indication of the collected parameters from all of the rental locations within the geographic divisions of the selected granularity.

In a further aspect of this invention, the organization selects a geographic division of a different granularity, before the parameter is collected from all of the identified vehicle transactions with the geographic division of the different granularity. The parameter may be selected from a group comprising expenditures, the day of the vehicle rental, the manner of payment and the miles that the vehicle was driven during the vehicle rental. In a further feature of this invention, each file includes a second parameter that indicates the date of the vehicle rental transaction. Further, a period to time is set as to the vehicle rental transactions of interest. The identified vehicle rental transactions are collected from those files with a second parameter that falls within the set period of time.

In a still further aspect of this invention, there is disclosed a method of constructing and accessing a database of vehicle rental information related to a plurality of employers and their employees, association of their members or travel agencies/tour operators of their customers, wherein at least one organization has an organization comprised of a plurality of divisions. The method comprises the steps of assigning to each vehicle renter an ID indicating the renter's affiliated organization and division, and constructing and inputting into a database a file for each vehicle rental transaction. Each file comprises the assigned ID of the vehicle renter involved in the vehicle rental transaction. Each organization is permissioned to access the database for only those files that includes an ID that matches the organization seeking access. Then, each permissioned organization selects the entire organization or division of interest, whereby data is collected from the files of the employees or customers assigned to the selected entire organization or division. Each file is constructed to include at least one parameter indicative of an attribute of the file's vehicle rental transaction, before the permissioned organization is permitted to select a different division or entire organization and collect the parameter from each of the files of the employee or customer assigned to the different division or entire organization. The parameter may be selected from a group comprising expenditures, the day of the vehicle rental, the manner of payment, and the miles that the vehicle was driven during the vehicle rental.

In a still further aspect of this invention, each file is constructed to include a plurality of parameters, which are indicative of different attributes of the file's vehicle rental transaction. The organization is enabled to select any combination of the plurality of the parameters and to generate a report of the data corresponding to the selected combination of parameters from the files of the employees or customers assigned to the selected division or entire organization.

In a further embodiment of this invention, at least one organization has an organization comprised further of a plurality of subdivisions. The organization is permitted to select a different one of the entire organization, division or subdivision, and collect the parameters from the files of the employee or customer assigned to the different entire organization, division or subdivision.

### BRIEF DESCRIPTION OF DRAWINGS

The foregoing objects and advantages of the present invention may be more readily understood by one skilled in the art with reference being had to the following detailed description of a preferred embodiment thereof, taken in conjunction with the accompanying drawings wherein like elements are designated by identical reference numerals throughout the several views, and in which:

FIG. 1 is a network topology diagram showing how the various physical parts of the system of the present invention are interconnected with each other.

FIG. 2 is a diagram showing how the various internal components of the computing device are interconnected with each other to implement this invention.

FIG. 3 is a data flow diagram, showing progression of data updates from an external source to the central database of the present invention.

FIGS. 4a-f are data layout diagrams showing fields comprising external source files entering the inventive system.

FIGS. 5a-e are data layout diagrams showing fields comprising four component groupings of the data of the central database of the present invention.

FIG. 6 is a list of records of exemplary data of some components of the central database of the present invention.

FIGS. 7a and b are a flow diagram of a key setting component of the data management process of the present invention, which determines the granularity of information displayed.

FIG. 8 is a flow diagram of logical steps undertaken by the present invention to generate a selected one of a plurality of reports.

FIGS. 9a to i illustrate variously the screens that are displayed to an user in the course of effecting the report generation processes shown in FIGS. 7a and b, and 8.

### DETAILED DESCRIPTION OF A PREFERRED EMBODIMENT OF THE INVENTION

The present invention provides apparatus and a method for managing rental information received from any outside source. The data received is diverse raw data conforming to the formats which will be described below. Even if these incoming sources and their formats may change, the historical information collected and managed on the inventive apparatus will not be affected.

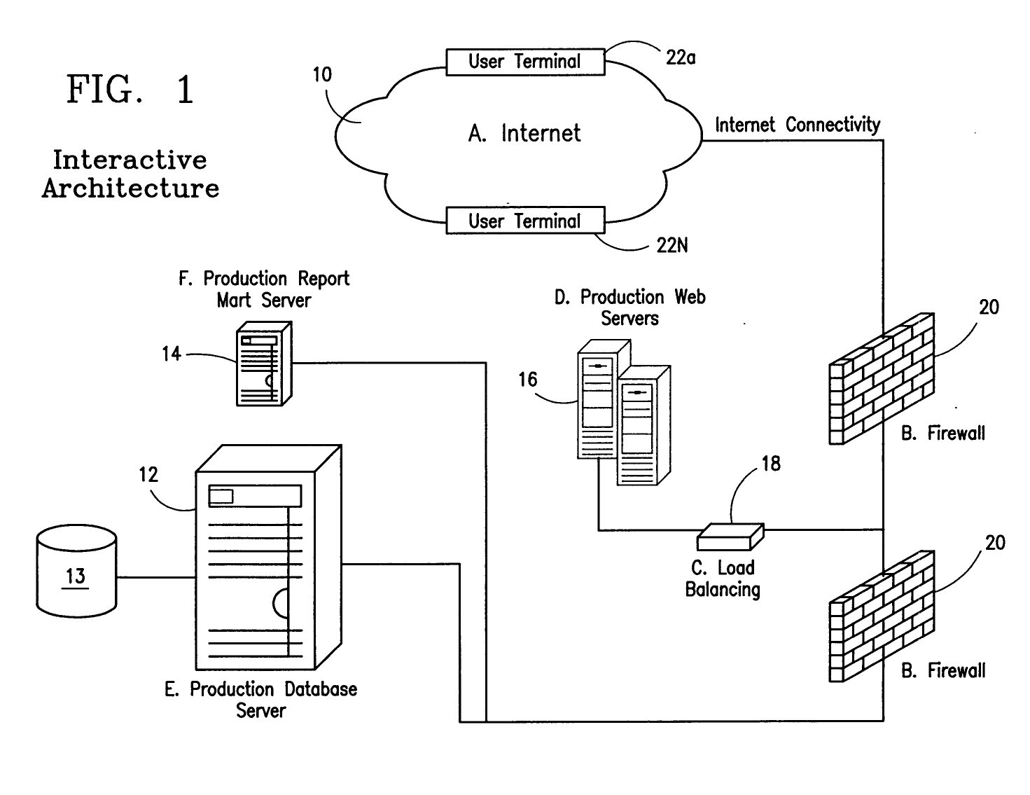

The inventive system may utilize in one illustrative embodiment of this invention the components shown in FIG. 1 to enable users of the invention to access information related to rentals and, in particular to vehicle rentals, via a network, which in the preferred embodiment of this invention is the Internet. However other connectivity, e.g., via a modem in a point to point connection or networks other than the Internet are within the contemplation of this invention. The system comprises one or more computing devices 12, which are used as a database server for managing data storage and retrieval for reporting database 13, one or more computing devices 14 for executing report generating and analysis processing, one or more computing devices 16 used for scalability and redundancy in connecting to the Internet 10, and one or more computing devices 18 used for load balancing to insure scalability of the inventive apparatus. A plurality of firewalls 20 to protect the infrastructure from unauthorized access may also be included. Further, a plurality of user terminals 22a-n are connected throughout the Internet 10 to permit users to access the reporting database 13 and to analyze the rental data stored therein in a manner as will be described below.

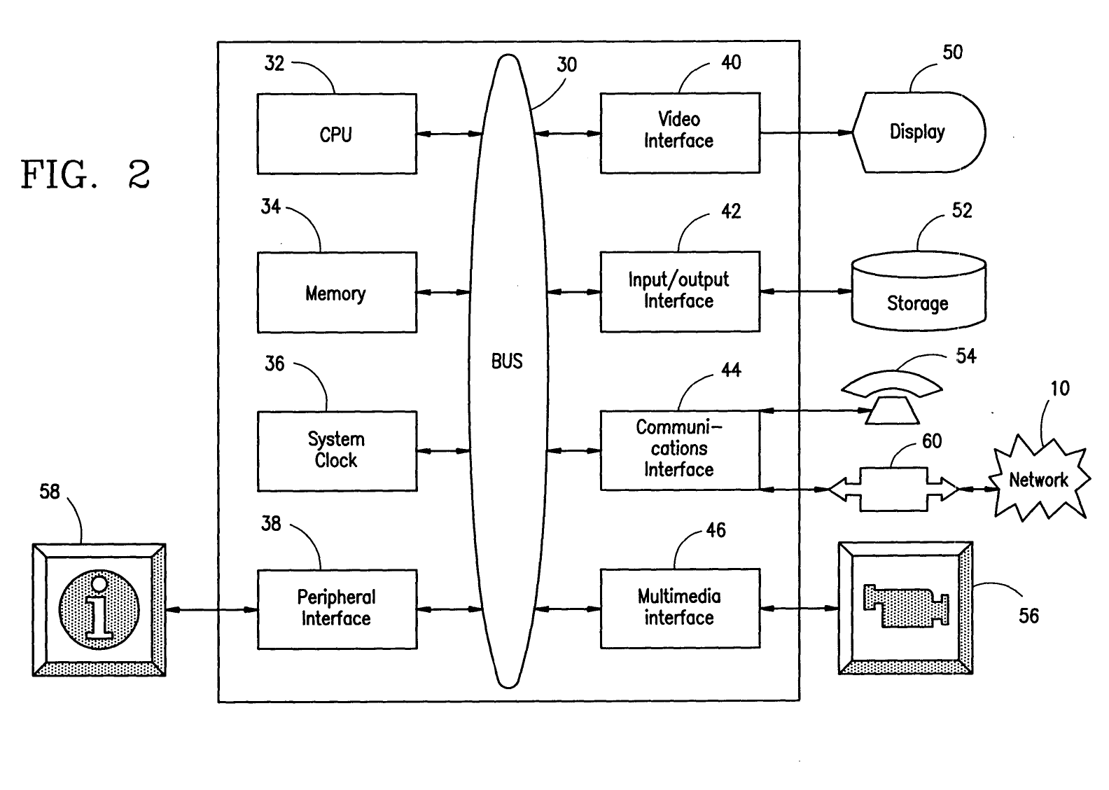

The computing devices 12, 14, 16, and 18, and the user terminals 22 may illustratively take the configuration of any computer ranging from mainframes to personal computers (PCs). In one illustrative embodiment of this invention as shown in FIG. 2, such computing devices and terminals may comprise a bus 30, which is connected directly to each of the following:

1. a central processing unit (CPU) 32;

2. a memory 34;

3. a system clock 36;

4. a peripheral interface 38;

5. a video interface 40;

6. an input/output (I/O) interface 42;

7. a communications interface 44; and

8. a multimedia interface 46.

The common bus 30 is further connected

9. by the video interface 40 to a display 50;

10. by the I/O interface 42 to a storage device 52, which may illustratively take the form of memory gates, disks, diskettes, compact disks (CD), digital video disks (DVD), etc.;

11. by the multimedia interface 46 to any multimedia component 56;

12. by a peripheral interface 38 to the peripherals 58, such as the keyboard, the mouse, navigational buttons, e.g., on a digital phone, a touch screen, and/or a writing screen on full size and hand held devices, e.g., a palm pilot™;

13. by the communications interface 44, e.g., a plurality of modems, to a network connection 60, e.g., an Internet Service Provider (ISP), and to other services, which is in turn connected to the network 10, whereby a data path is provided between the network 10 and the computing devices 12, 14, 16, and 18 (FIG. 1) and, in particular, the common bus 30 of these computing devices; and

14. furthermore, by the communications interface 44 to a wired and/or a wireless telephone system 54.

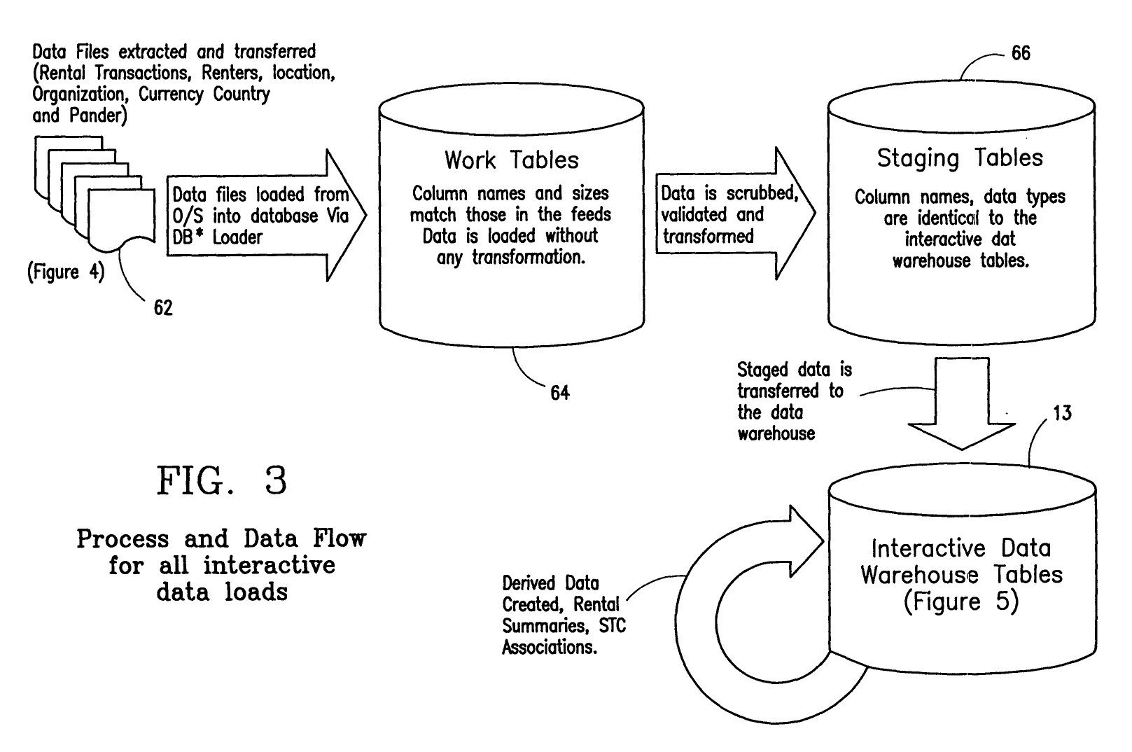

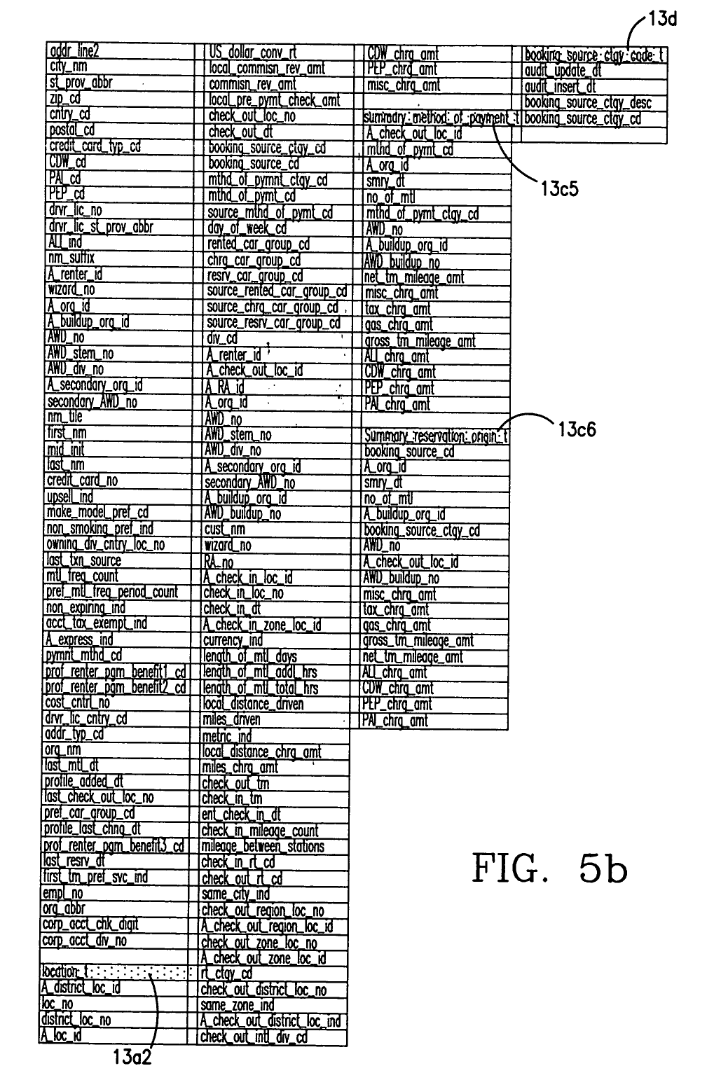

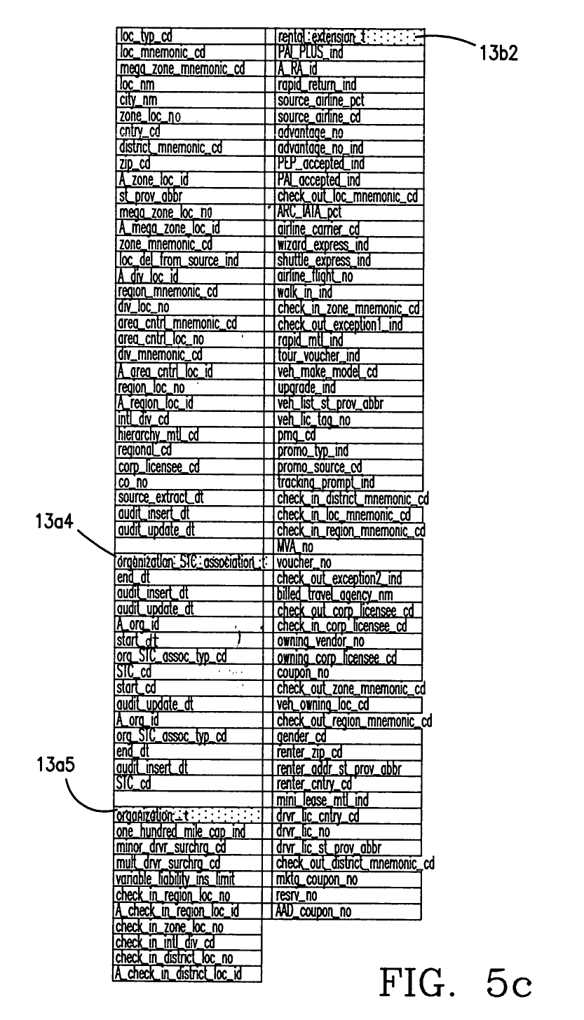

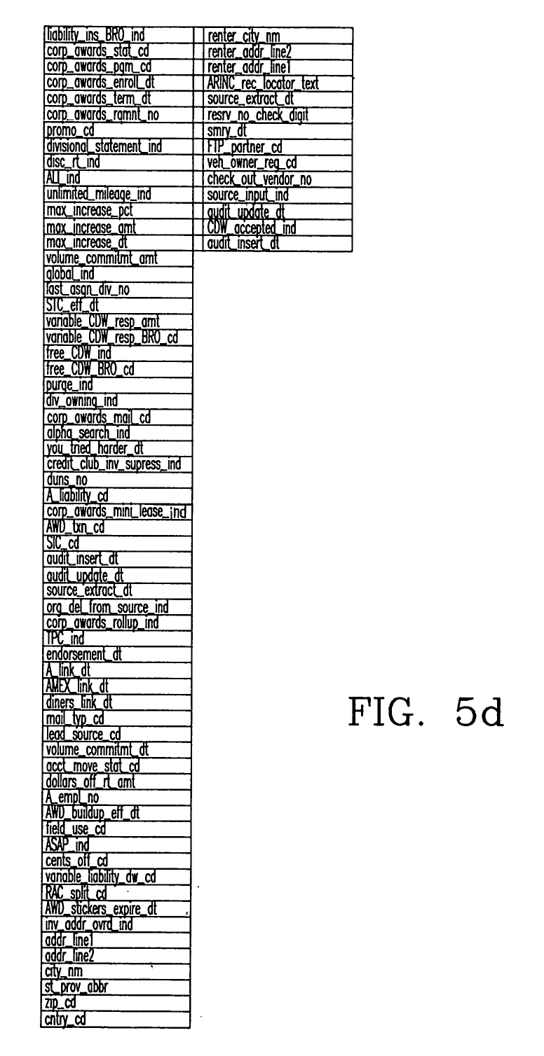

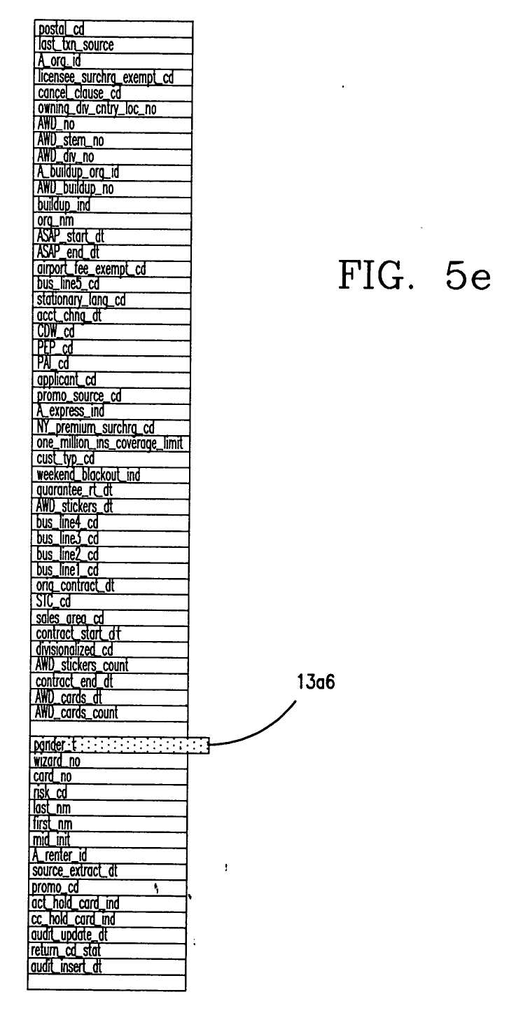

FIG. 3 shows the initial creation and/or daily/weekly/monthly building of a set of interactive data warehouse tables in the reporting database 13 as will be explained below with respect to FIG. 5. The design and creation of the reporting database 13 is intended to provide enhanced reporting features and capabilities for analysis purposes. Many of these features are built into the architecture of the database 13 and include:

1. Building of transaction summary tables 74 (FIG. 5) to facilitate the quick generation of summary reports.

2. Ability to retain data for a time period longer than the period of retention provided in the source system.

3. Strategic use of controlled redundancy to increase performance of the interactive system and to simplify its use.

4. Indexing designed specifically to facilitate the reporting process.

5. Reporting naming standards developed to ensure consistency across the database 13.

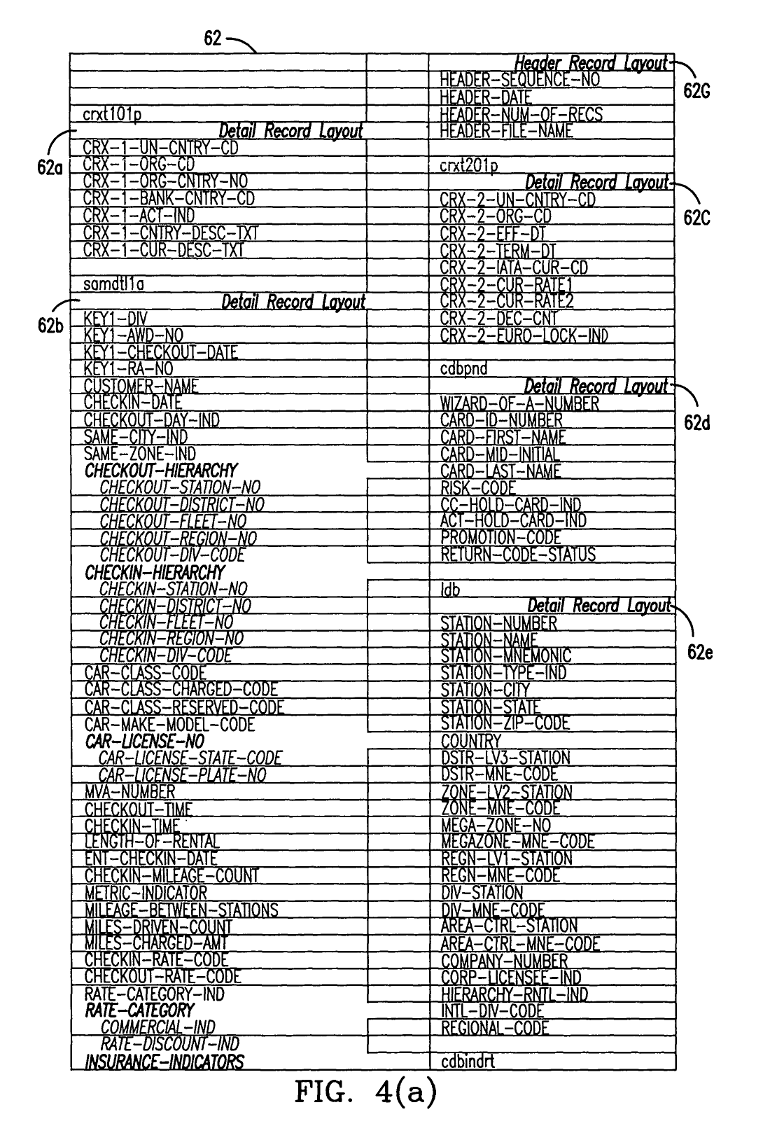

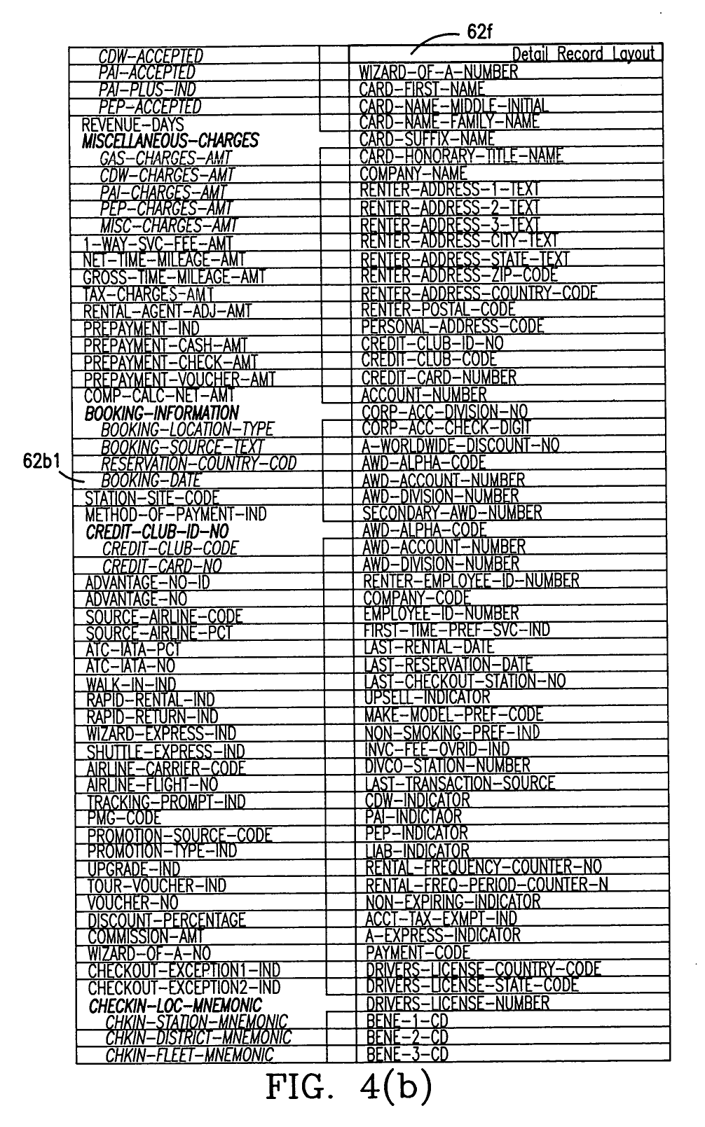

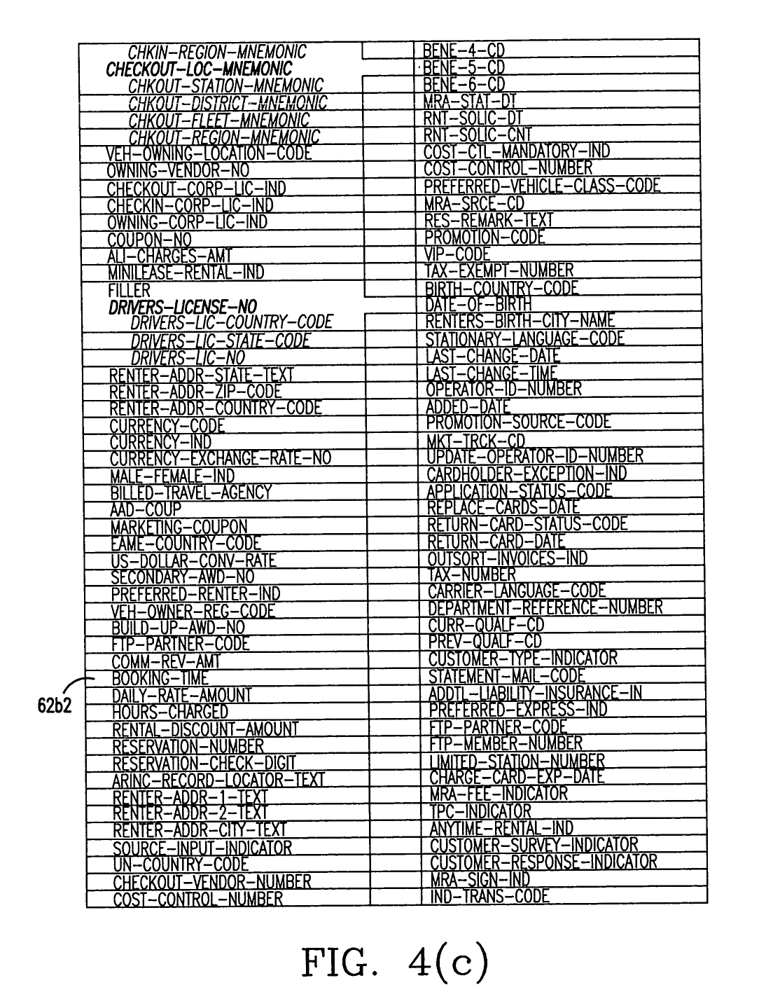

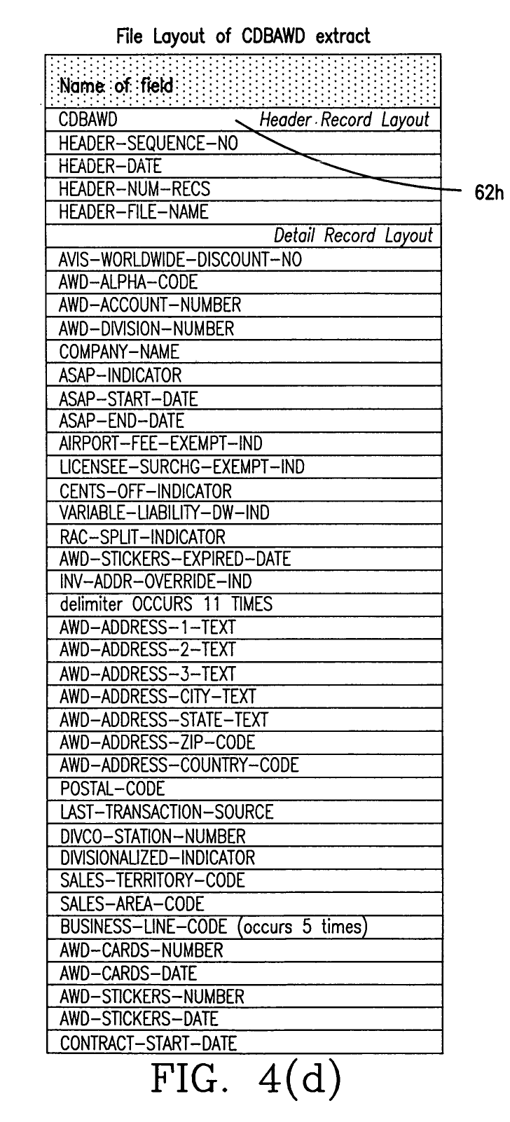

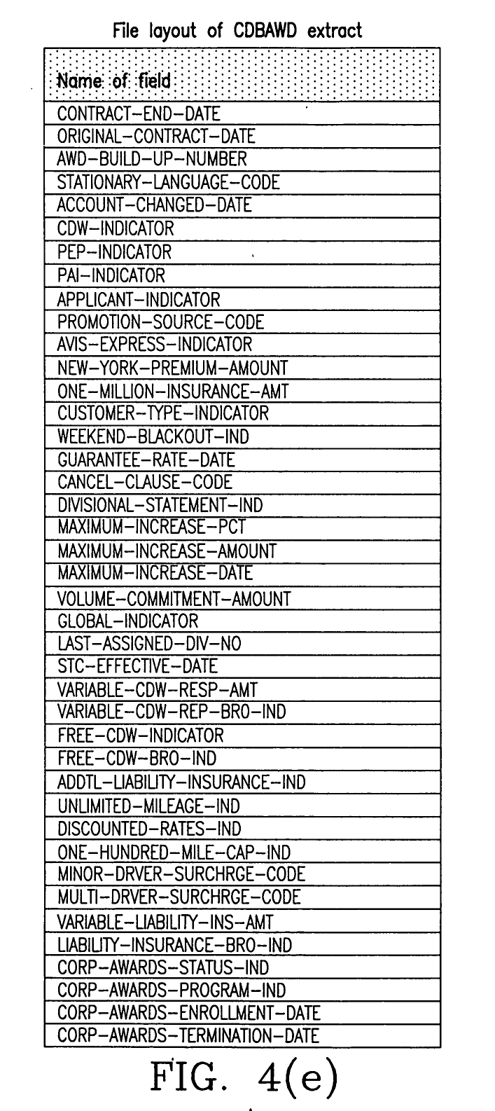

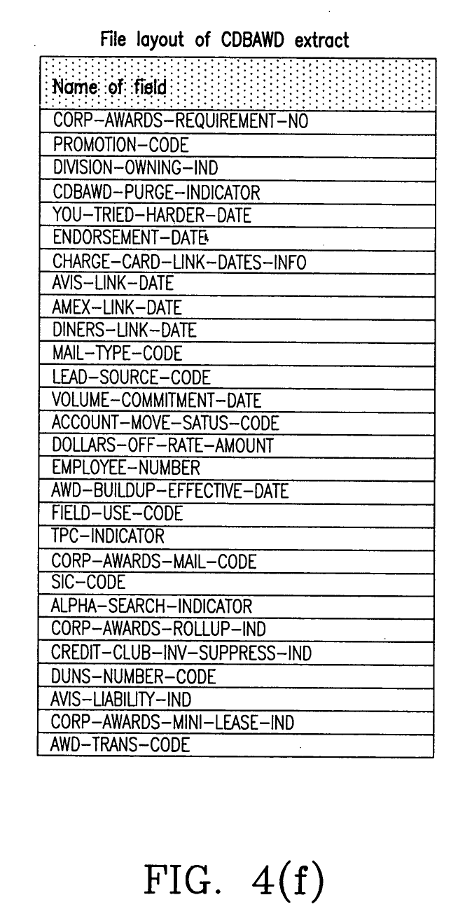

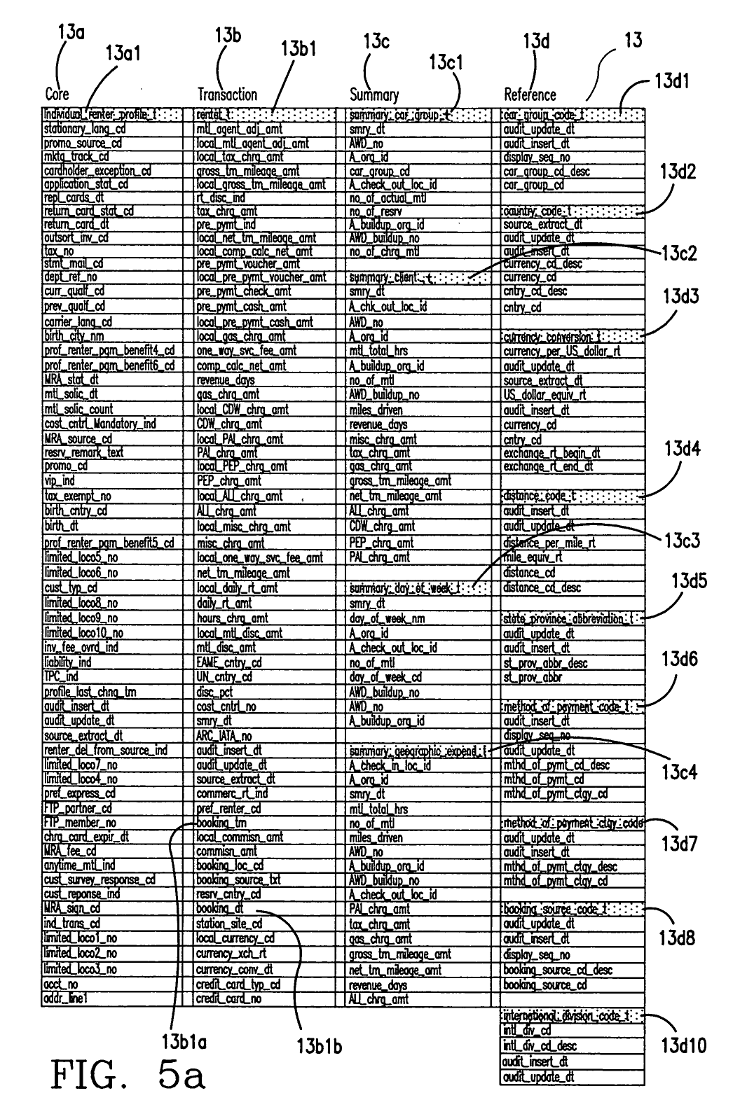

The system receives data files 62 which include transactional data, e.g., renter, location, organization, currency, country and pander information. These data files 62 may come directly from rental outlets after individual transaction data are executed, from a reservations facility where records of reservations are kept. In a preferred embodiment of this invention, daily transactions are stored in central or distributed databases, which comprise the data noted in the background, and from which the data files 62 may be built and transmitted to the system and apparatus of this invention. It is appreciated that the preferred central distributed databases of this invention are essentially similar to those of the large vehicle rental companies, e.g., Hertz, Budget, Dollar, etc., and that data files from their databases could be readily processed by the method and apparatus of this invention without departing from the scope of this invention. The record layout of six of the data files 62 is shown in FIGS. 4a-4c. In the present illustrative embodiments, there are six files 62a to 62f, each comprising a similar header record 62g. These files provide the following information:

1. Country codes tables 62a;

2. Detailed information for the individual rental transaction table 62b;

3. Currency conversion rates (both current and historical) tables 62c;

4. The pander file used to exclude individual renters from the lists of individual renter profiles produced for the corporate customers' table 62d;

5. Information about the individual rental locations table 62e;

6. Information about the individual renters table 62f, where each renter is identified by a unique number; and

7. Information about a table 62g containing company profiles of corporate customers (including associations and tour operators), where each organization is identified by a unique Worldwide Discount (AWD) number.

Returning now to FIG. 3, data files 62 are loaded into a work tables database 64, where the data record column names and sizes match those in the data files 62. In other words, the data files 62 are loaded into the work tables database 64 without any transformation. The received data is scrubbed, validated, and transformed into a staging tables database 66, where the data record column names and data types are identical to the interactive data warehouse tables 13a-d, which are constructed in the reporting database 13. The data from the staging tables database 66 is then transferred and added to the reporting database 13.

The process of data transfer from the data files 62 into the reporting database 13 effectively transforms six variously formatted record collections 62a-b 62f as shown in FIG. 3 into four groups or warehouse tables 13a-13d of interactive data shown in FIGS. 5a-e. Each of the main categories of tables 13a-13d within the reporting database 13 is briefly described below.

1. The core data tables 13a comprise information central to the rental business. This information is usually used across applications due to its fundamental importance to the business. Examples include information about organizations, individuals, and locations, such as the following:

a. table 13a1 of information about the individual renter;

b. table 13a2 of information about the individual rental locations;

c. table 13a4 contains the current assignment of Sales Territory Codes (STC) to organization accounts (STC is used to assign particular geographic areas to the sales staff. For example, a regional head of the sales department for the US northeast may be assigned the code of 400000. That person will be allowed to see all of the transactions with the codes 400199 to 409999. The head of a New York division is assigned an STC of 400100. That person will be able to access all records or transactions with the codes 400100 to 409999);

d. table 13a5 of organization profiles of corporate, association or tour operator customers;

e. table 13a6 of information used to exclude individual renter profiles from the employee/renter profile lists.

2. The transaction data tables 13b comprise business events, e.g., rental transactions that are incurred by core data instances, e.g., organizations and individuals. The transaction data tables 13b includes a table 13b1 comprising the most frequently accessed detail information for individual rental transactions, e.g., identity of renter, dates of rental, rental check-out and check-in locations, miles driven, rates charged, etc., and a table 13b2 comprising additional detail information for individual rental transactions, e.g., renter address, driver's license number, etc.

3. The summary data tables 13c comprise a pre-summarized view of transactional data. These tables are primarily built to provide increased performance when the data is being presented at a high to intermediate level. The tables include the following:

a. summary_car_group table 13c1 for summarizing numbers of the rentals reserved, charged and rented using an AWD, the check-out location of each rental, the month/year of each rental and the car or vehicle group of each rental

b. summary_client table 13c2 for summarizing rental activity according to its AWD, check-out location and month/year of occurrence

c. summary_day_of week table 13c3 for summarizing number of rentals according to its AWD, check-out location, and month/year and day of the week of its occurrence

d. summary_geographic_expenditures table 13c4 for summarizing number of rentals, expenditures and distance traveled (miles or kilometers) according to its AWD, check-out location, check-in location, and month/year of occurrence

e. summary_method_of payment_table 13c 5 for summarizing rental activity using the AWD, check-out location, month/year and method of payment

f summary_reservation_origin table 13c5 for summarizing rental activity according to its AWD, check-out location, month/year of occurrence and source of reservation (booking source)

4. The reference data tables 13d are also commonly known as “code” tables. These tables provide the ability to convert code values into descriptive phrases to make the data more informative; they include the following:

a. car_group_code table 13d1;

b. country_code table 13d2;

C. currency_conversion table 13d3;

d. distance_code table 13d4;

e. state_province_abbreviation table 13d5;

f. method_of payment_code table 13d6;

g. method_of payment_ctgy_code table 13d7;

h. booking_source_code table 13d8;

i. booking_source_category_code table 13d9; and

j. international_source_division_code table 13d1

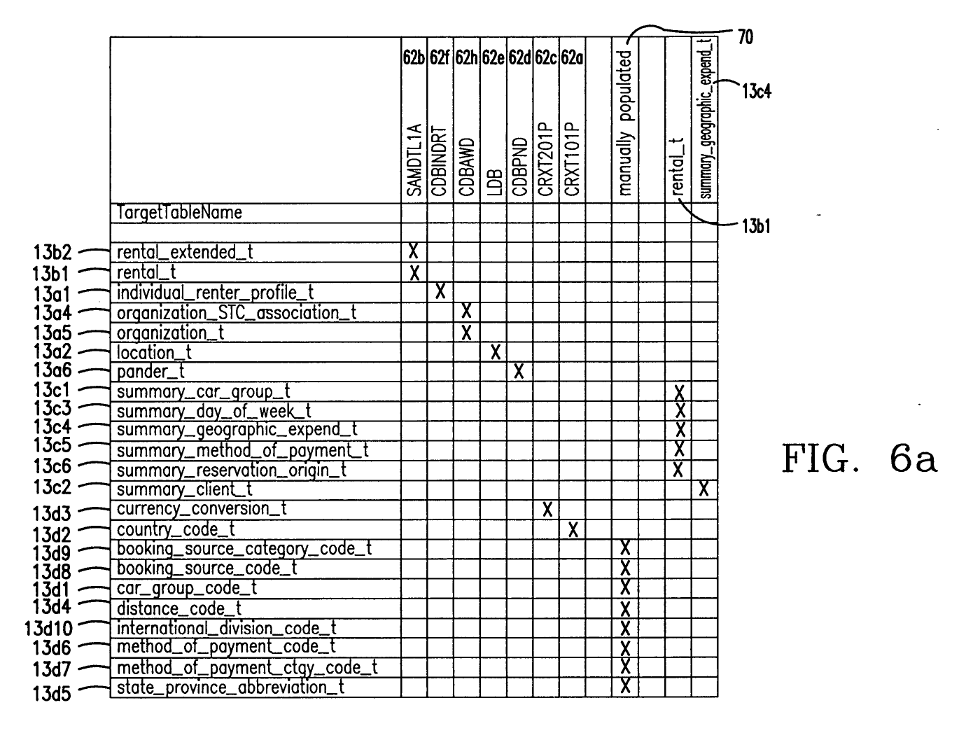

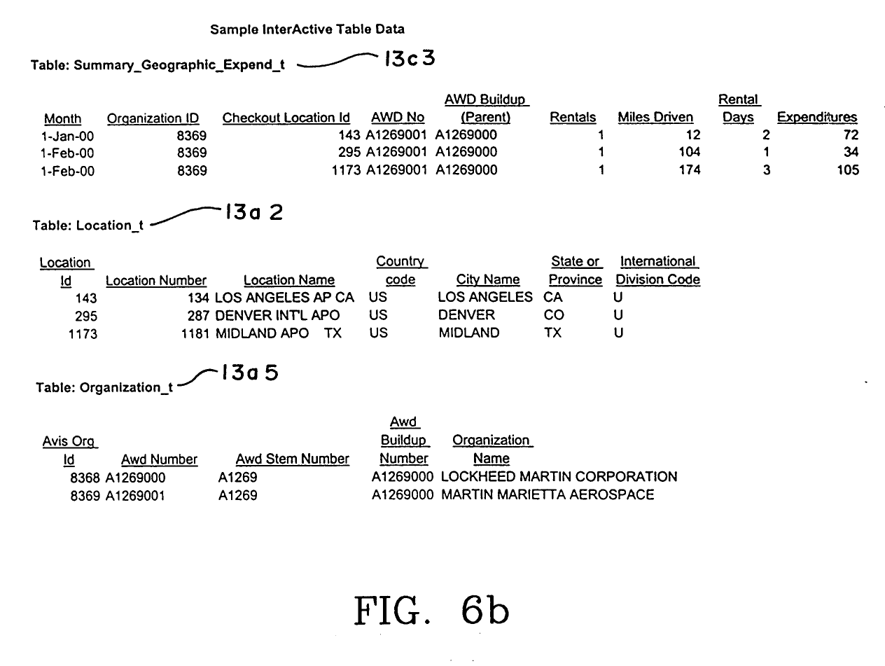

FIG. 6a shows a table of the relationships between the input 62a-f (FIG. 3) and the various groupings of data in the recording database 13, i.e., warehouse tables 13a-d, (FIGS. 3 and 5a-f). In FIG. 6a, the data files 62 are disposed as the columns of the table, whereas the data groupings or warehouse tables 13 are disposed as the rows. The x at the intersection of a column/row pair indicates that data from a particular source data file 62 (FIG. 3) populates a particular table 13 of the reporting database 13 (FIG. 3). For example, the data from the cdbpnd input file 62d is used to populate or is added to the pander table 13a6 as indicated by the “x” in FIG. 6a. Moreover, formerly created tables, e.g., the rental table 13b1 (rental_t), may populate the summary tables like 13c1, 13c3, 13c4, 13c5 and 13c6. The reference tables 13d (FIG. 5a) may be manually populated at column 70. FIG. 6b shows samples of representative data of some of the created tables of the reporting database 13 (FIG. 3). Namely, shown are a summary geographic expenditures table 13c3, a location table 13a2 and an organization table 13a5.

The identity of data is kept for historical purposes, even though such data may have been deleted from the source and the source identifier reused to identify different data. This is achieved through the use of surrogate keys assigned in the reporting database 13 (FIG. 3). These surrogate keys are the identifiers referenced in the table descriptions that follow. For example, a location in the source file 62 (FIG. 3) has a location number code of “123.”When this location is loaded to the interactive Data Warehouse reporting data database 13 (FIG. 3), the transferred data is assigned a unique location ID. If this location is deleted from the source system, e.g., the rental company is sold or consolidated, it will be flagged as deleted from the source data 62 (FIG. 3) in the interactive reporting database 13 (FIG. 3). If the location number “123” is later reused on the source system for a new location, e.g., in a different part of the country, it will be assigned its own unique location ID, when it is loaded to the interactive reporting database 13 (FIG. 3). In this way, it is possible to maintain the history for each use of the location ID.

Returning once again to FIG. 3, the data loaded in the reporting database 13 is scrubbed, validated and transformed by program units stored in the reporting database 13. A code generator developed for this invention used the mapping document to generate 90% of the code for the stored program units. In addition to reducing the time necessary to collect information and to generate reports, the generated code is highly accurate.

Some actual data from the mapping document is presented in Table 1.

TABLE 1

| TARGET | | SOURCE |
|---|---|---|
| TABLE | TARGET COL | TABLE/COL |
| rental_t | booking_dt | samdtlla.booking-date |
| rental_t | booking_tm | samdtlla.booking-time |

For each of the two samples in Table 1, the code generator produced a line of code which calls a special routine that transfers the data from the target table 62b(FIG. 4a), the column “samdtl1a.booking-date 62b1” (FIG. 4b) and the “samdtl1a.booking-time 62b2” (FIG. 4c) to the target database transaction table 13b at columns “rental_t.booking_dt 13b1b” (FIG. 5a) and “rental_t.booking_tm 13b1a” (FIG. 5). The code generation relied on a complete and accurate mapping document, the field names or work table 64 columns named in accordance with the column or field names of the input source data or files 62, and on the stage table 66 column names being the same as the database target column names of the data base target tables 13.

Data Analysis

The data analysis aspect of this invention allows a user to review and analyze a large number of parameters related to the rental transactions, that include at least those listed above. In a preferred embodiment of this invention, the Internet connects a wide variety of users to the reporting database 13 as shown in FIG. 1. These users may include for example the renter, e.g., a vehicle renter, the managers of the rental company, the managers of the company whose employees rent and the brokers such as travel agents who take reservations directly from the renters and place the orders for such rentals. The users may review a significant number of the parameters that relate to the rental transactions. For example, these parameters may include the total expenditures, the number of rentals, the percent of worldwide rentals, the rental days, the average distance in miles or kilometers that the rental vehicle or car is driven per day, the average distance driven per rental, and the average length of rentals. The user may choose to view the expenditures in various world currencies. Distance figures traveled by particular vehicle renters may be viewed in either kilometers or miles. The user may choose the date range to view the data, e.g. January 1999 through December 1999. The historical data may be maintained indefinitely.

To begin requesting the rental information, the user may use any of the user terminals 22a-n as shown in FIG. 1, whose structure was described with reference to FIG. 2, and any commercially available web browser, such as the Microsoft Explorer and the Netscape Navigator, to establish a data path via the Internet 10 to one of the user terminals 22a-n. After establishing a data path, the user may be authenticated and allowed to request any pertinent information found on the reporting database 13 (FIG. 3). The authentication of users may be achieved by any of a number of well known techniques familiar to these skilled in the art.

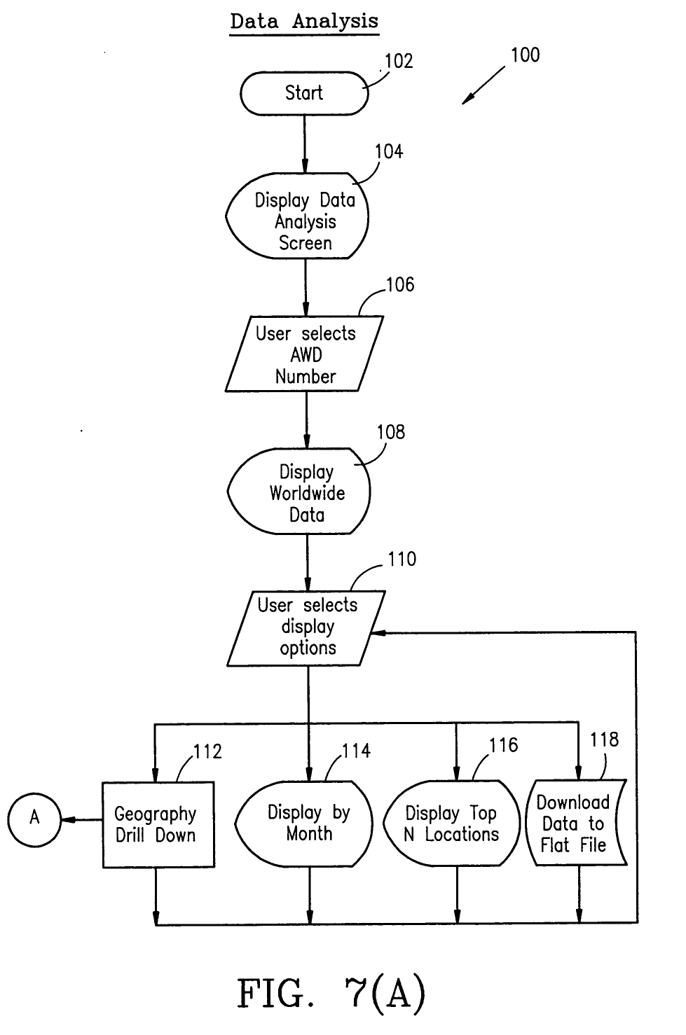

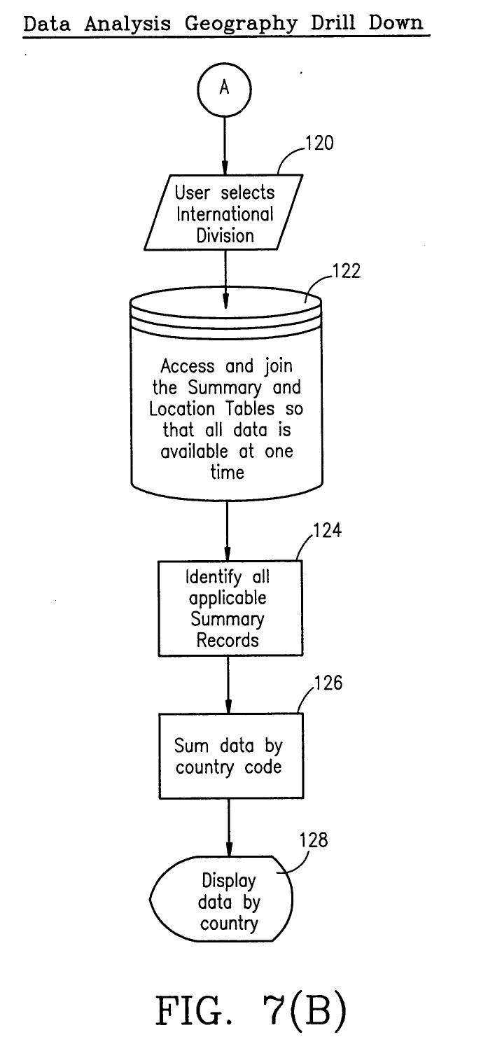

As will now be explained with respect to FIGS. 7a and b, the user may request selected information about and summary reports of selected parameters of the rental transactions. In the particular embodiment of this invention that will be described below, the rental transactions are vehicle rentals. In this embodiment, the processing illustratively includes a geographic explorer and an AWD explorer. Generally, these explorers permit the user to analyze or “drill down” to different layers of information, each lower level presenting more detailed information.

The geographic explorer has application to at least one embodiment of this invention, wherein the rental company has a large number of rental locations distributed in a number of countries through out the world. In each typical country, the vehicle rental locations are found in a number of states or provinces, a number of cites in each state or province, and a plurality of street locations in certain ones of the cities. The geographic explorer permits, as will be explained below, the user to access or “drill down” to each of these geographic levels and to collect or sum data related to selected rental vehicle parameters at that particular level. For example, an user has the option of collecting in the following illustrative embodiment data at the following geographical levels: 1) worldwide; 2) country groups; 3) countries; 4) states or provinces; 5) cities; and 6) street locations.

The “AWD” explorer is used in that embodiment of the invention, where the user's employer/company is structured into divisions at various levels. The organization is divided at a first level into its largest divisions. In turn, each of these largest divisions may be further divided into subdivisions or sections at a second level. Further subdividing the organization structure into lower or smaller units is also contemplated by this invention. In a manner similar to that of the geographic explorer, the “AWD” explorer is capable of accessing or “drilling” down to data related to various levels of the renter's corporate structure. The “AWD” explorer is used extensively through out the user's terminal 22 to aid the user in selecting the organizational unit that is identified by its “AWD” number or ID that the user is interested in viewing data for. The “AWD” identifies that portion of the user's organization (the whole company, a division, or a sub-division). The “AWD” explorer looks at the user's security profile and allows the user to view only the “AWD” numbers that the user is authorized to view. The “AWD” explorer displays the hierarchy of the “AWD” numbers.

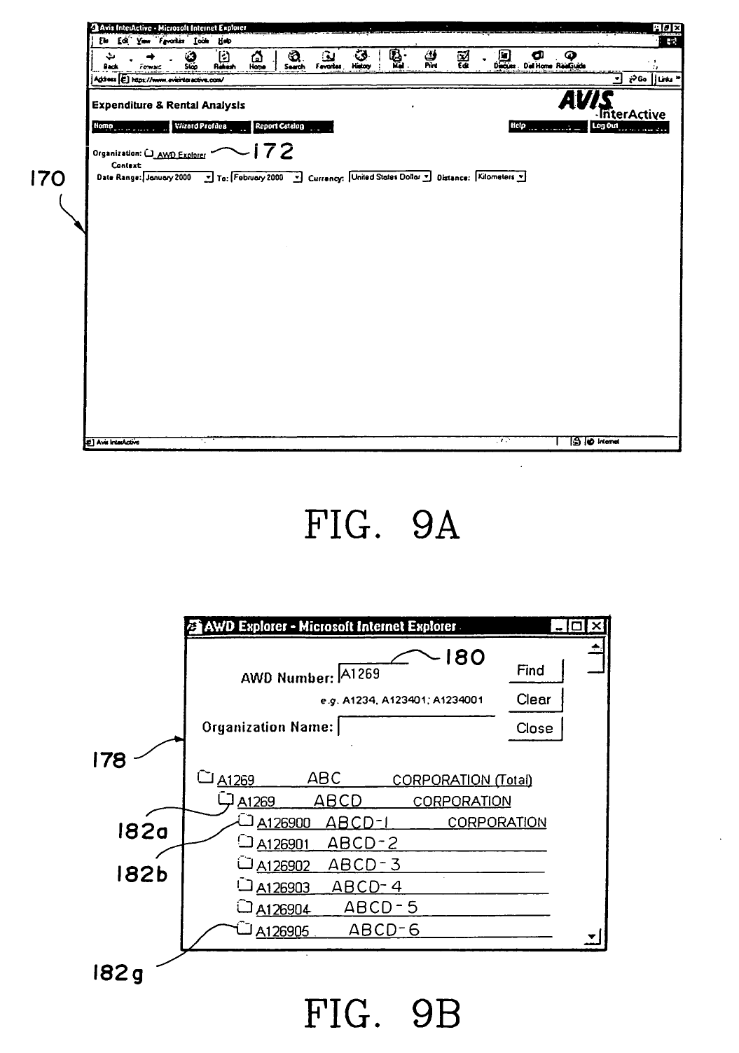

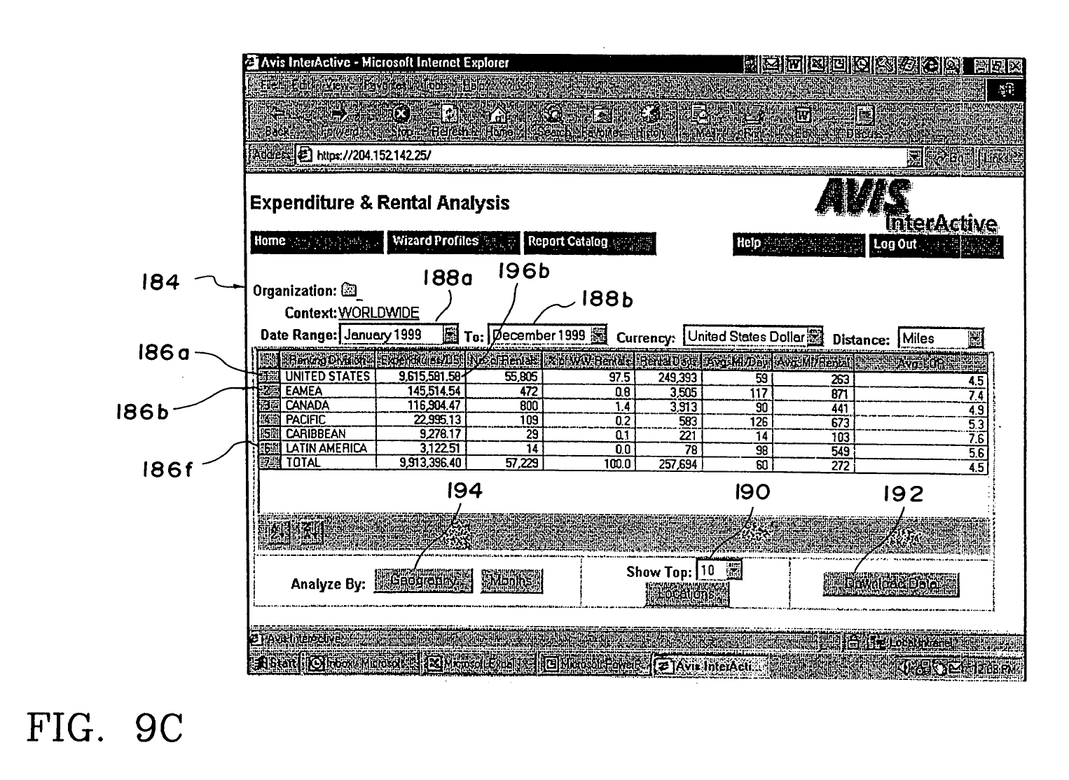

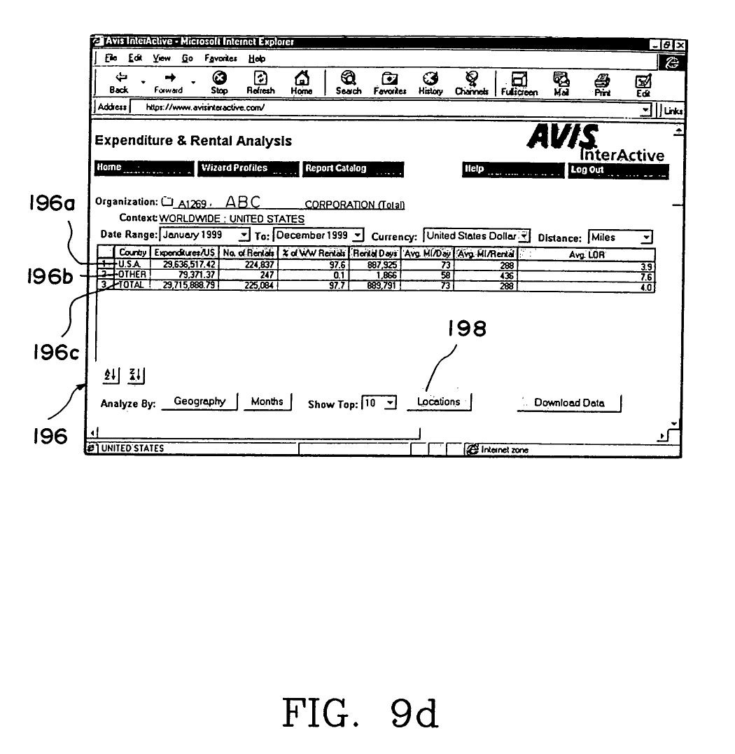

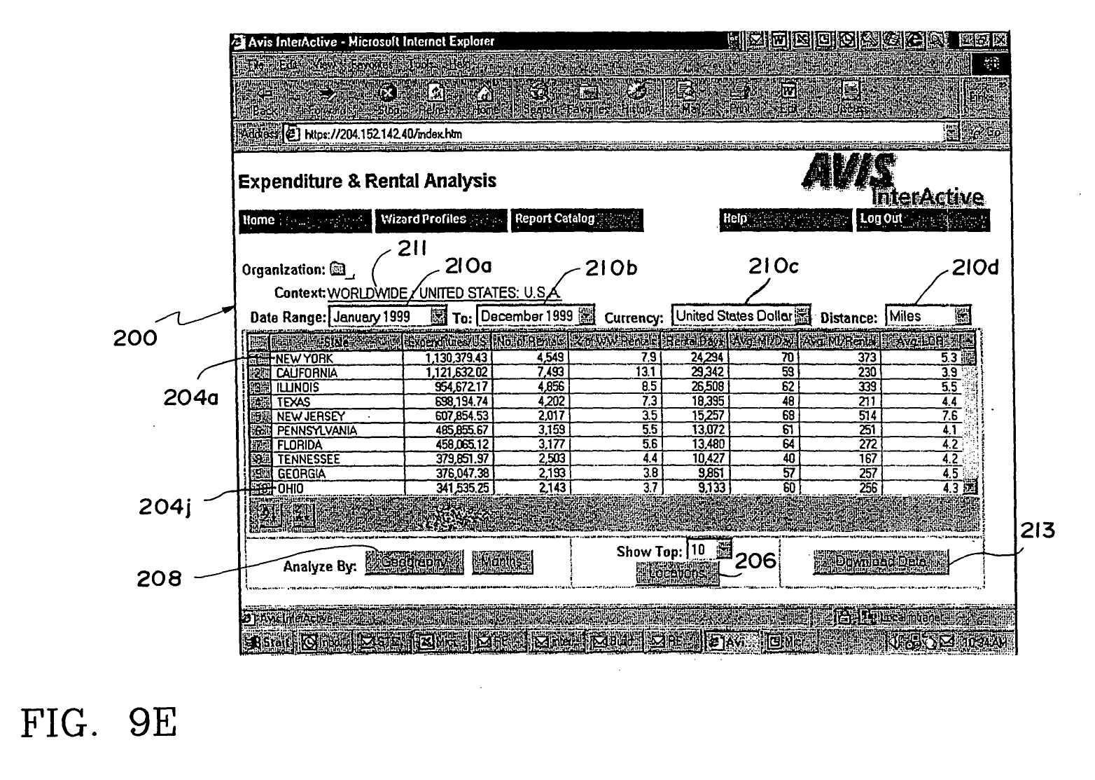

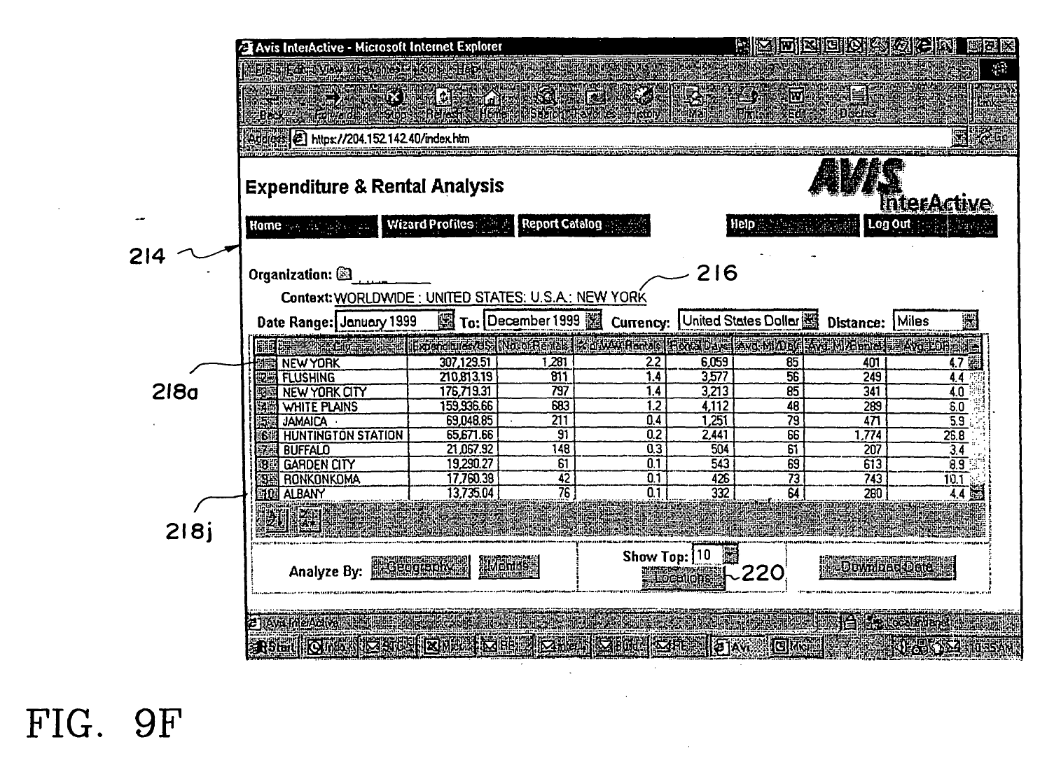

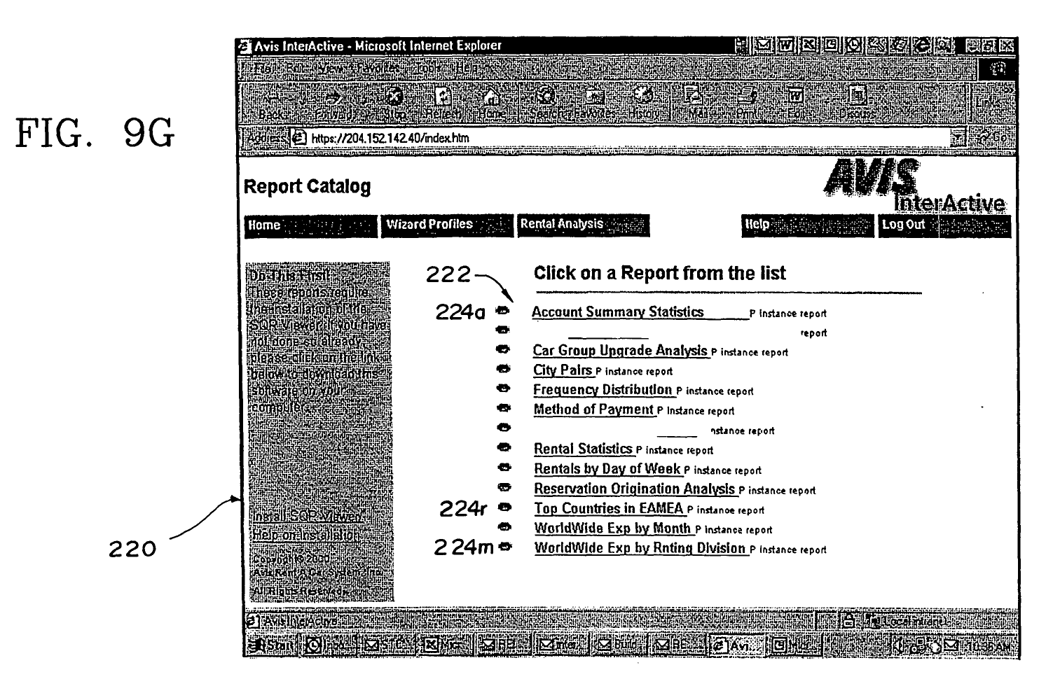

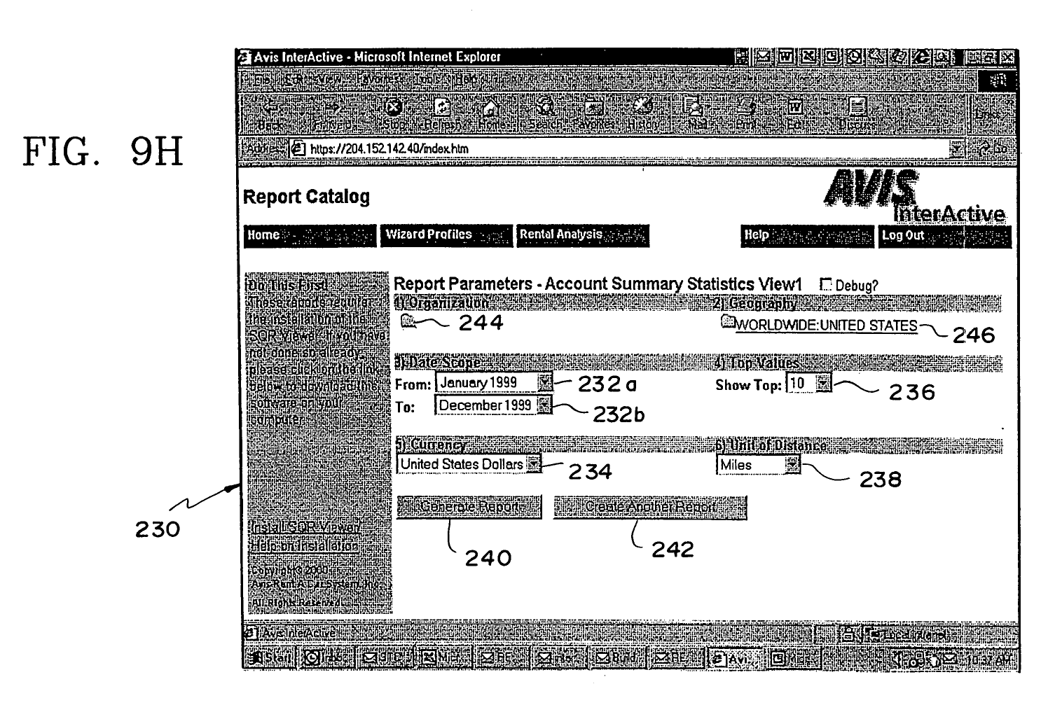

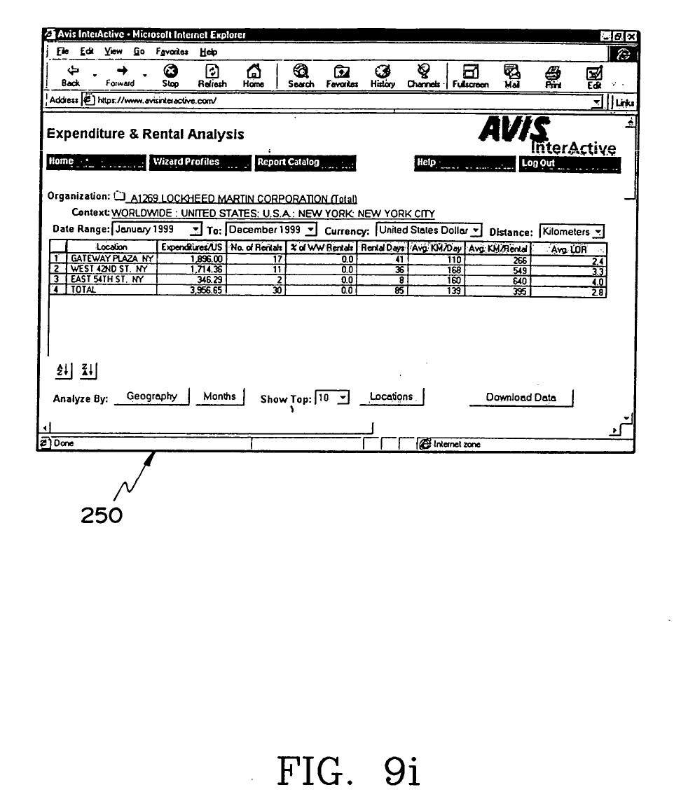

Referring now to FIG. 7a, the data analysis process starts in step 104, which downloads from the reporting database 13 via the Internet 10 to one of the user terminals 22a-nas shown in FIG. 2, a screen 170 as shown in FIG. 9A to be presented on the user's display 50. Screen 170 and the others to be so displayed to the user, permit the user to select and analyze the rental data. The user clicks on an “AWD” explorer link 172, which effects the display in step 106 of a screen 178 as shown in FIG. 9B. The screen 178 includes a block 180, in which the user may enter his/her “AWD” number or organization name, which in turn causes the display of a first set of links bearing the respective names of the divisions of the renter's employer at a first level, only one of which is identified in FIG. 9b by the numeral 182a. FIG. 9b also shows a second set of links bearing respectively the names of a plurality of subdivisions 182b-g at a second lower level. The user may then click on a selected one of the links 182a-g to “drill down” and to access data of a corresponding division at the first level or to data of a section at the second level.

Responding to the selection of a particular division or section of the company, the process displays in step 108 as shown in FIG. 7a a screen 184 which is shown in FIG. 9c as bearing data relating to the selected division or section on a world wide basis. As shown in FIG. 9c, the expenditures are displayed for the U.S. in block 186a, the EAMEA countries in block 186b, Canada in block 186c, the Pacific countries in block 186d, the Caribbean countries in block 186e and the Latin American countries in block 186f.The screen 184 further includes blocks 188a and b, 190 and 192. The user may click on blocks 188a and b to set a range of dates, i.e., January 1999 to December 1999, whereby in step 114 rental data related to this time period is collected and displayed by the screen 184. For example, the amount displayed in block 196b represents the rental expenditures expressed in U.S. dollars for the named organization from January 1999 through December 1999 for vehicle rentals from all rental locations in the U.S. The user may click on the button 190, whereby step 116 sorts the rental data and identifies the top number of locations for a particular parameter. In the screen 184 of FIG. 9c, all geographic divisions are displayed in blocks 186a-g in order of the rental expenditures spent in each of these geographic divisions. Further, the user may click on button 192, whereby step 118 down loads from the reporting database 13 any information provided to the user, e.g., the data currently displayed by the screen 184 to the web browser, to a text file. The text file can be imported into any commonly available spreadsheet programs and word processors and other PC software, that is maintained at the user's terminal 22.

If the user would now like to see information about the rental locations in the next lower level of the geographic divisions, i.e., the “international divisions” and, in particular, the UNITED STATES, the user clicks on a button 194 of the screen 184, whereby step 112 (FIG. 7a) begins a geographic “drill down”. Next in step 120 as shown in FIG. 7b, the user selects by clicking on the block 186a of the screen 184 (FIG. 9c) that corresponds to the selected international division, i.e., the UNITED STATES. Then, step 122 selects certain data from the Summary-Geographic-Expend table 13c3 and the Location table 13a2 as shown in FIG. 6b. In this illustrative example, the user is collecting rental data relative to the UNITED STATES, which has the International Division Code “U”. The process accesses data related to the UNITED STATES in the Location table 13c3 by using its code “U”. One row of data bearing the code “U” relates to Los Angeles and further includes the Location ID 143, which points to the related data row in the Summary table 13c3 that also bears a Location ID 143 as shown in FIG. 6b. These rows from tables 13a2 and 13c3 are joined in step 122 into a single elongated row in preparation for further processing. In particular, step 124 (FIG. 7B) identifies all of the elongated rows, known as summary records, that relate or apply to certain parameters. In this example, the parameter is International divisions and, in particular, the UNITED STATES which is identified by the International division code “U”. Thus step 124 identifies all summary records identified by or with the code “U”, before step 126 sums the rental data identified by parameter or for all of the “U” identified summary records. Though the steps 122, 124 and 126 are shown separately, these steps are carried out substantially simultaneously. Though only a few records are illustrated in FIG. 6b, the number of summary records so identified in step 124 and summed in step 126 may number in the hundreds, the thousands and potentially more. The summed data from step 126 is then displayed in a screen 196 shown in FIG. 9d. In particular, data analysis has drilled down to the next or international level whereby U.S. expenditures may be displayed. As explained above, the user may actuate step 114 (FIG. 7a) again to view the data summed by month and year. The user may actuate step 116 (FIG. 7a) again to identify the top N (10, 25, 50, 100, all) locations in the selected country in blocks 196a-c by expenditures. If the user wishes to “drill down” to the next lower level, i.e., the country level, the user again actuates step 112 (FIG. 7a) to create and display a screen 200 as shown in FIG. 9e for a selected country, e.g., U.S.A. If the user wishes to “drill down” down further to the state or province level, the user again actuates step 112 to produce a screen 214 as shown in FIG. 9f for a selected state, e.g., New York. If the top N button 220 is clicked again, the expenditures for the top N locations will be displayed in blocks 218a-218j. In a similar fashion, the user can actuate the step 112 to again “drill down” to the city level and to produce a screen 250 as shown in FIG. 9i for a selected city, e.g., New York City. It is within the scope of this invention to “drill down” to an individual renter level. The sort buttons can be used to sort the data in either ascending or descending order. The user clicks on any column in the grid and presses the appropriate sort button (ascending, descending). Drop downs 210a and 210b (FIG. 9E) can be used to designate the date range for the data of interest, e.g. from January 1999 to December 1999. Drop down 210d is used to change currency displayed. Drop down 210d is used to change the distance parameter data. Link 211 is used to allow the user to “drill up” through the various geographic levels. Button 213 is used to allow the user to down load the data displayed to a text file.

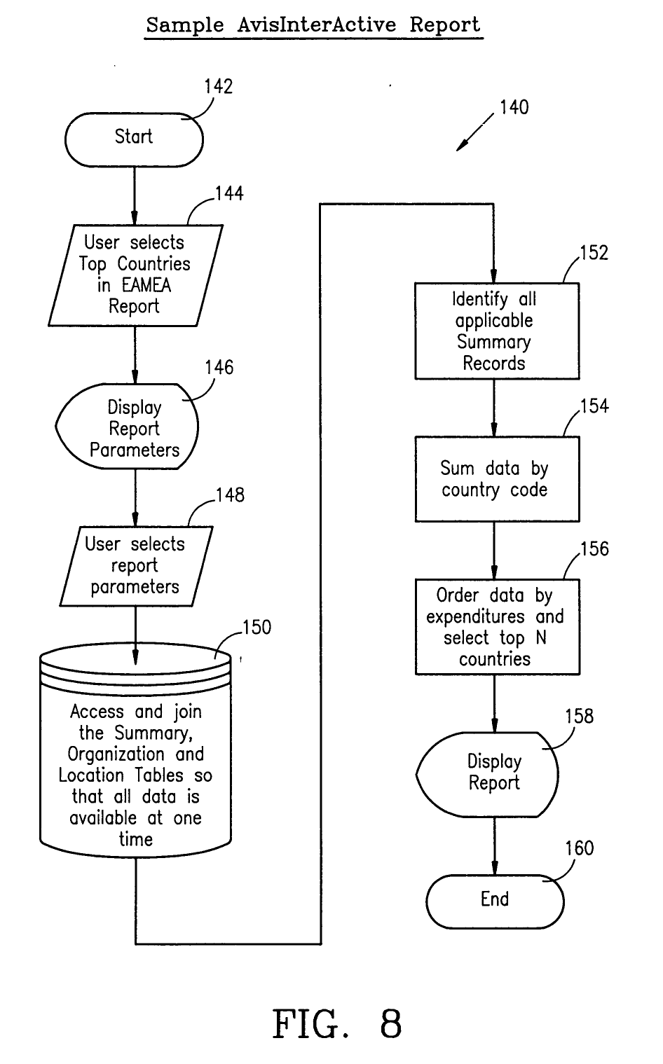

The user uses the process shown in FIG. 8 to generate a variety of reports about selected of the rental parameters, e.g., the geographic entity or a time period of interest. When the user selects the Report Catalog option, step 144 displays a screen 220 as shown in FIG. 9g that bears a list or menu 222 of reports which this particular embodiment is capable of assembling and generating. It is contemplated that other reports as would include other combinations of rental parameters are within the scope of this invention. Each report includes a button 224a-m, which the user may click on to generate that report. For example if the user clicks on button 224k, the “Top Countries in EAMEA” report will be generated. After selection of a particular report, step 146 displays a screen 230 as shown in FIG. 9h, which displays a plurality of parameters that may be reported by the selected report. The user may click in step 148 (FIG. 8) on a pair of buttons 232a and b to set the limits of the time period of interest, a button 244 to select the company of interest, a button 246 to select the geographic level and unit of interest, a button 234 to set the currency of interest, and a button 238 to set the units of distance of interest, i.e, miles or kilometers. In step 150, selected of the data in the Summary-Geographic-Expend table 13c3, the Location table 13a2 and the Organization table 13a5 (all shown in FIG. 6b) are accessed and joined according to the selected parameters. For example, if the user selects in step 148 data related to “Martin Marietta Aerospace” as the organization of interest, step 150 uses that company's or row's Organization ID number to link to the corresponding row in the Summary table 13c3. That row in the Summary table 13c3 uses its Checkout Location ID to link to the corresponding row in the Location table 13a2. These three rows are arranged in an elongated row or Summary record, where all of this information is available at one time. Next, step 152, identifies all of the Summary records, and step 154 sums the data in all of the identified Summary records by the selected country code or parameter. Though separate steps 150, 152, 154 and 156 are shown, it is appreciated that the functions of these four steps are carried out substantially simultaneously. Still referring to FIG. 8, step 156 responds to the clicking of button 236 (FIG. 9h) to access and sort the countries within the selected International division, in this example EAMEA, for expenditures to provide a list of the top 10 countries by total expenditures. Next step 158 generates a report (not shown) of the expenditure of EAMEA and the other parameters selected in step 148.

Renter/Employee Profiles List

The renter/employee profile list feature allows the user to download profiles for employees in their organizations. They can choose to download all profiles for the entire company or for a particular division or subdivision of the employer/company (“AWD”explorer). The employer can choose to download all profiles or only those that have been added or updated since a certain month and year. These profiles contain information such employee name, address, identification number or ID, credit card information and insurance preferences.

Security

The security portion of this system is used to manage user access to the website and to the specific data that the user can access. Users can be setup with one (or more) of three different roles: an interactive user, security officer, and password change officer. An interactive user cannot access the security functions of the system, a security officer can only access the security features. A password change officer can change another user's password (help desk). A user can have more than one role.

Interactive users are restricted to the specific data they can view in one of three ways. A user is either “All”, “AWD”, or “STC”, An “All” user has access to all data in the system. An “AWD” user (external customer) can only access certain AWD's data. A Sales Territory Codes (STC) user (internal sales user) can only access the AWDs associated with his/her STC code. When the security officer sets up an AWD user, he/she uses the AWD explorer to select the applicable AWD numbers. The security module allows the security officer to create new user IDs, modify existing user IDs, delete user IDs, change passwords, and unlock or lock a user's ID.

While the invention has been particularly shown and described with respect to illustrative and preferred embodiments thereof, it will be understood by those skilled in the art that the foregoing and other changes in form and details may be made therein without departing from the spirit and scope of the invention that should be limited only by the scope of the appended claims.

Having thus described our invention, what we claim as new, and desire to secure by Letters Patent is:

1. A method of constructing and accessing a database to permit an organization of the renters to analyze vehicle transaction information, said method comprising the steps of:
a) inputting to the database a plurality of files, each file defining a vehicle rental transaction, each file comprising a parameter indicative of the vehicle rental location in terms of a plurality of geographical divisions of different granularity and a parameter indicative of an attribute of its vehicle rental transaction;
b) permitting the organization to select the granularity of the geographic division and identifying the vehicle rental transactions from the geographic division of selected granularity; and
c) collecting the parameter from all of the identified vehicle rental transactions to provide an indication of the collected parameter from all of the rental locations within the geographic division of the selected granularity.

2. The method of constructing and accessing as claimed in claim 1, wherein said selecting step b) is repeated to permit the organization to select a geographic division of a different granularity, before repeating step c) to collect the parameter from all of the identified vehicle transactions with the geographic division of the different granularity.

3. The method of constructing and accessing as claimed in claim 1, wherein said parameter may be selected from a group comprising expenditures, the day of the vehicle rental, the manner of payment and the miles that the vehicle was driven during the vehicle rental.

4. The method of constructing and accessing as claimed in claim 1, wherein said parameter is numerically quantifiable.

5. The method of constructing and accessing as claimed in claim 4, wherein said quantifiable parameters are selected from a group comprising: the expenditures, and the number of the days of the rental transaction.

6. The method of constructing and accessing as claimed in claim 5, wherein step a) inputs files to the database, each file of which includes a second parameter that indicates the date of the vehicle rental transaction.

7. The method of constructing and accessing as claimed in claim 6, wherein there is further included the step of setting a period of time as to the vehicle rental transactions of interest, and collecting from the identified vehicle rental transactions those files with a second parameter that falls with the set period of time.

8. The method of constructing and accessing as claimed in claim 4, wherein there is further included the step of sorting the quantifiable parameters collected by the magnitude of the summed parameter.

9. A method of constructing and accessing a database of vehicle rental information related to a plurality of organizations and their renters, at least one organization having a structure comprised of a plurality of divisions, said method comprising the steps of:
a) assigning to each vehicle renter an ID indicating the renter's affiliated organization and division;
b) constructing and inputting into a database a file that includes data for each vehicle rental transaction, each file comprising the assigned ID of the vehicle renter involved in the vehicle rental transaction;
c.) permissioning each organization access to the database for only that vehicle rental transaction data which includes an ID that matches the organization seeking access; and
d) facilitating each permissioned organization to select the entire structure or division of interest and to collect vehicle rental transaction data of the renters assigned to the selected entire structure or division.

10. The method of constructing and accessing as claimed in claim 9, wherein step b) constructs each file to include at least one parameter indicative of an attribute of the vehicle rental transaction data, and step d) is repeated to permit the permissioned organization to select a different division or entire structure and collect said parameter from each of the vehicle rental transaction data of the renters assigned to the different division or entire structure.

11. The method of constructing and accessing as claimed in claim 9, wherein said parameter may be selected from a group comprising expenditure, the day of the vehicle rental, the manner of payment, and the miles that the vehicle was driven during the vehicle rental.

12. The method of constructing and accessing as claimed in claim 9, wherein step b) constructs each file to include a plurality of parameters, each parameter indicative of a different attribute of the vehicle rental transaction data, and there is further included the step of facilitating the employer to select any combination of said plurality of said parameters and to generate a report of the data corresponding to the selected combination of parameters from the vehicle rental transaction data of the renters assigned to the selected division or entire structure.

13. The method of constructing and accessing as claimed in claim 9, wherein at least one organization has a structure comprised further of a plurality of subdivisions, and step d) is repeated to permit the perrmissioned organization to select a different one of the entire structure, division or subdivision and collect said parameter from the vehicle rental transaction data of the renter assigned to the different entire structure, division or subdivision.

14. A method of constructing a database and facilitating at least one user to access information regarding a plurality of vehicle rental transactions, wherein each of said plurality of vehicle rental transactions is provided by one of a plurality of vehicle rental outlets, each of said plurality of vehicle rental outlets is located in one of a plurality of geographic divisions, said method comprising the steps of:
a) inputting in the database information which is indicative of which of said plurality of geographic divisions each of said plurality of vehicle rental outlets is in;
b) facilitating the one user to select the geographic division from which information regarding at least one of said plurality of vehicle rental transactions is to be accessed; and
c) identifying each of the vehicle rental transactions provided by any of said plurality of vehicle rental outlets located in said selected geographic division.

15. The method of constructing and facilitating as claimed in claim 14, wherein one of said plurality of geographic divisions is of a higher granularity than another geographic division of said plurality, and said step a) further inputs data information as to what the granularity of each of said plurality of geographic divisions is.

16. The method of constructing and facilitating as claimed in claim 14, wherein said step b) further facilitates the one user to select the granularity of said geographic division from which information regarding at least one of said plurality of vehicle rental transactions provided.

17. The method constructing and facilitating as claimed in claim 14, wherein said step b) facilitates the user to select the granularity of the selected geographic division.

18. The method of constructing and facilitating as claimed in claim 16, wherein there is included the further step of identifying the vehicle rental transaction from which the geographic division of the selected granularity is provided.

19. The method of constructing and facilitating as claimed in claim 14, wherein each of said plurality of vehicle rental transactions includes an attribute of its vehicle rental transaction, and there is included the further step of collecting the attribute from all of the identified vehicle rental transactions to provide an indication of the collected attributes from all of the rental locations within the selected geographic division respectively.

20. The method of constructing and facilitating as claimed in claim 19, wherein said attribute may be selected from a group comprising the day that the vehicle was rented, the day on which the vehicle rental terminated, the manner of payment, the miles that the vehicle was driven during the vehicle rental, and the cost of the rental transaction.

21. The method of constructing and facilitating as claimed in claim 14, wherein each of said geographic divisions has a granularity selected from a plurality thereof.

22. The method of constructing and facilitating as claimed in claim 21, wherein each of said plurality of granularities is selected from a group comprising street addresses, cities, states, provinces, countries and combinations of countries.

23. A method of constructing a database and facilitating at least one user to access information regarding a plurality of vehicle rental transactions, the database storing the vehicle rental transaction information; said method comprising the steps of:
a) inputting to the database a plurality of files, each file comprising information about a single vehicle rental transaction, each file comprising an indication of at least one attribute of the single vehicle rental transaction; and
b) collecting from each of said plurality of filed information concerning respectively each of said plurality of vehicle rental transaction and providing an indication of the collected information that relates to said attribute.

24. The method of constructing and facilitating as claimed in claim 23, wherein said one attribute is selected from a group comprising the cost of the vehicle rental, the day that the vehicle rental started, the day that the vehicle rental ended, the manner of payment and the distance that the vehicle was driven during the vehicle rental.

25. The method of constructing and facilitating as claimed in claim 23, wherein each of said plurality of vehicle rental transactions is provided by one of a plurality of vehicle rental outlets, and each of said plurality of vehicle rental outlets is located in one of a plurality of geographic divisions.

26. The method of constructing and facilitating as claimed in claim 23, wherein there is further included the step of inputting in the database information which is indicative of which of said plurality of graphic divisions each of said plurality of vehicle rental outlets is in.

27. The method of constructing and facilitating as claimed in claim 26, wherein there is further included the step of facilitating the one user to select the geographic division from which information regarding at least one of said plurality of vehicle rental transaction is to be accessed.

28. The method of constructing and facilitating as claimed in claim 26, wherein there is the further step of identifying each of the plurality of rental transactions provided by any of said plurality of vehicle rental locations in said selected division.

29. The method of constructing and facilitating as claimed in claim 27, wherein there is further included the step of accessing said data base and collecting all of said identified attributes in said selected geographical division.

30. A method of constructing a database to enable at least one user to monitor the occurrence of a plurality of transactions, each of said plurality of transactions occurring at one of a plurality of geographic divisions, each of said transactions having at least one of a plurality of attributes, said method comprising the steps of:
a) entering data into said database indicating in which one geographical division where the transaction occurred, and indicating said one attribute of said corresponding transaction;
b) facilitating the one user to select said one of the plurality of geographical divisions and said one of the plurality of attributes; and
c) accessing said database and collecting all selected attributes in said selected geographical division.

31. The method of constructing as claimed in claim 30, wherein step A enters into the data base a plurality of files, each file defining a transaction, each file comprising an indication of which one geographical division where the transaction occurred and said one attribute of said corresponding transaction.

32. The method of constructing as claimed in claim 30, wherein said transaction is a vehicle rental transaction.

33. The method of constructing as recited in claim 30, wherein said geographic divisions comprise a selected of street addresses, cities, states, provinces, countries and combinations of countries.

34. The method of constructing as claimed in claim 32 is selected from the group comprising the method of payment, the duration of the rental transaction, the date that the rental began, the date that the rental ended, the manner of payment and the miles that the vehicle was driven during the vehicle rental.
